(19) United States
(12) Patent Application Publication
(10) Pub. No.: US 2005/0045110 A1
(43) Pub. Date: Mar. 3, 2005

(54) Disposable bird feeder

(75) Inventor: John Franck JR., City of Industry, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: House of packaging, City of Industry, CA (US)

(21) Appl. No.: 10/641,396

(22) Filed: Aug. 13, 2003

(51) Int. Cl. A01K 61/02

(52) U.S. Cl. 119/57.8

(57) ABSTRACT

A container that selectively dispenses items contained therein. The container includes a body that includes two opposing openings and a removable dispensing tray that may be coupled with the body with a snap-in-coupling. The tray includes two opposing openings also. When the body is coupled to the tray, the body and tray may rotate relative to one another such that the openings may be aligned to an open position so that items may move from the body to the tray. The openings may be misaligned to a closed position so that items are prevented from moving from the body to the tray. The container and tray combination are especially suitable for a disposable bird feeder.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

1. Field of the Invention

The present invention relates to bird feeders, and more particularly, to a disposable bird feeder that is made of a deformable plastic and is packaged with bird feed already included therein.

2. Description of Prior Art

Bird watching is an extremely popular activity. This is especially true at houses where the residents enjoy observing the birds in the comfort of their own back yard or from the comfort of their own house. Thus, many types of bird feeders are available. Most of these bird feeders are made of durable materials. Such bird feeders need to be refilled. Thus, large bags of bird feed need to be purchased and stored. Additionally, these durable bird feeders can be bulky and difficult to move. Thus, they are generally expensive and are inconvenient if one only wishes to temporarily attract and feed birds.

### SUMMARY OF THE INVENTION

Broadly, the present invention provides a container that selectively dispenses items contained therein. The container includes a body that includes two opposing openings and a removable dispensing tray that may be coupled with the body with a snap-in-coupling. The tray includes two opposing openings also. When the body is coupled to the tray, the body and tray may rotate relative to one another such that the openings may be aligned to an open position so that items may move from the body to the tray. The openings may be misaligned to a closed position so that items are prevented from moving from the body to the tray.

In accordance with one aspect of the present invention, the container includes two openings defined within the body and they are diagonally opposed from one another. The tray includes two openings that are also diagonally opposed from one another.

In accordance with another aspect of the present invention, the container includes a circular neck with a cover that includes the two openings defined therein. The tray includes a web and includes a circular depression with the openings defined therein. The circular neck fits within the circular depression in order to couple the tray and the container together.

In accordance with a further aspect of the present invention, holes are defined within the tray.

In accordance with yet another aspect of the present invention, the container is a disposable bird feeder and consists of deformable plastic.

In accordance with a further aspect of the present invention, the container includes structure for inhibiting rotation between the body and the tray via an interference fit.

In accordance with another aspect of the present invention, the structure comprises cooperating ribs defined within the body and the tray.

In accordance with a further aspect of the present invention, the tray includes two compartments that each include at least one deep portion defined therein.

In accordance with yet another aspect of the present invention, the web is welded to the tray.

Thus, the present invention provides a container that may be used to dispense product from the container into a tray. A container in accordance with the present invention is especially suitable for use as a disposable bird feeder. The container may be provided with bird feed, generally in the form of bird seed, within the container and the tray may be snap-fit to the container and then shipped to stores and/or users. The tray and body may rotate relative to one another to misalign openings defined in both pieces and thus, product within the body is retained therein. By rotating the tray and body relative to one another, the openings may be aligned and thus, product within the container may be dispensed into the tray.

The following detailed description together with the accompanying drawings will provide a better understanding of the nature and advantages of the present invention.

### BRIEF DESCRIPTION OF THE DRAWINGS

FIG. 1 is a side elevation view of a container and tray in accordance with the present invention;

FIG. 2 is a top plan view of a cap for the container;

FIG. 3 is a side elevation view of the cap;

FIG. 4 is a top plan view of the container with the cap;

FIG. 5 is a top plan view of the tray prior to folding a web;

FIG. 6 is a top plan view of the tray after folding the web;

FIG. 7 is a side elevation view of the tray after folding the web;

FIG. 8 is a top plan view of a larger tray after folding a web; and

FIG. 9 is a side elevation view of the larger tray after folding the web.

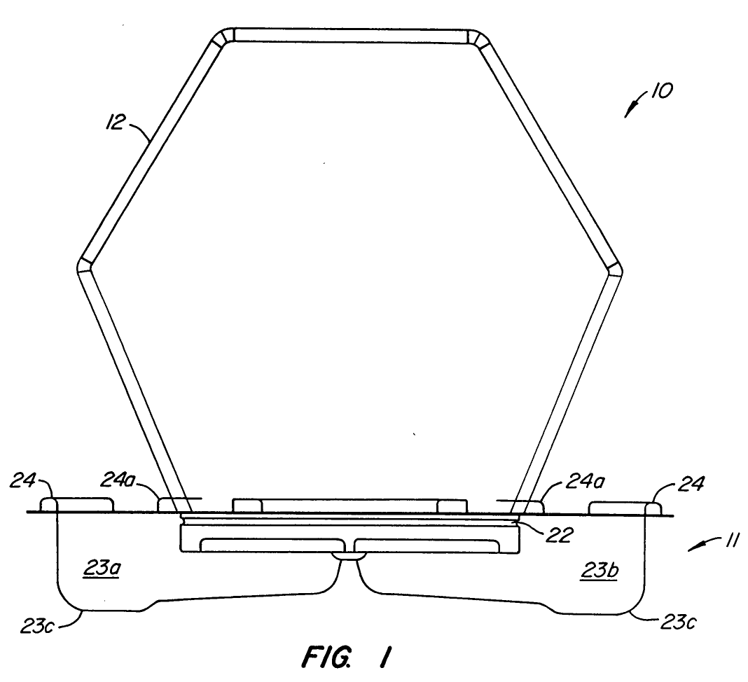

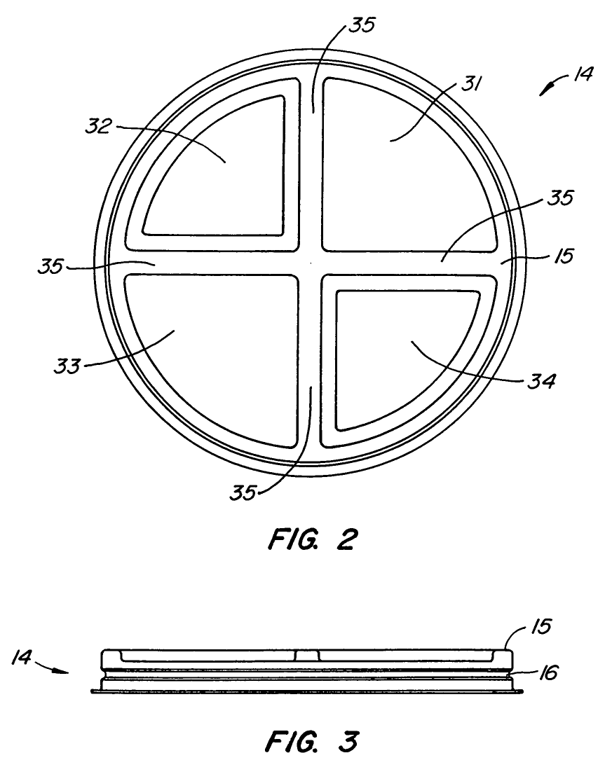

### DETAILED DESCRIPTION OF THE INVENTION

The present invention provides a container 10 that includes a dispensing tray 11. As may be seen in the figures, the container includes a primary body 12 that preferably includes a circular neck 13. Preferably, cap 14 is placed over the circular neck and includes a ridge 15 defined around the periphery of the cover and a depression 16 defined in the side of the cap that extends around the periphery. Alternatively, the cap may actually be part of the body depending upon how the body and cap are made such that the body and cap are a one-piece unit. Preferably, the container and tray are made of deformable plastic in a manner known in the prior art. This allows the container and tray combination to be reusable or disposable as desired. While the figures illustrate the body as having a preferred shape, those skilled in the art will understand that many other shapes are suitable for use with the present invention.

As previously noted, the present invention is especially suitable for a bird feeder and thus, will be described as such for simplicity and clarity. Those skilled in the art will understand that the container and tray combination in accordance with the present invention may be used for other purposes.

The dispensing tray preferably includes a circular receptacle 20. The receptacle includes a depression 21 and a protrusion 22. Thus, the tray is placed on the container (or the container is placed on the tray) such that the neck of the container is within the receptacle of the tray. Ridge 15 on the cap protrudes into depression 21 defined within the receptacle while tray protrusion 22 protrudes into cap depression 16, thus helping keep the tray coupled to the container with a snap-in coupling.

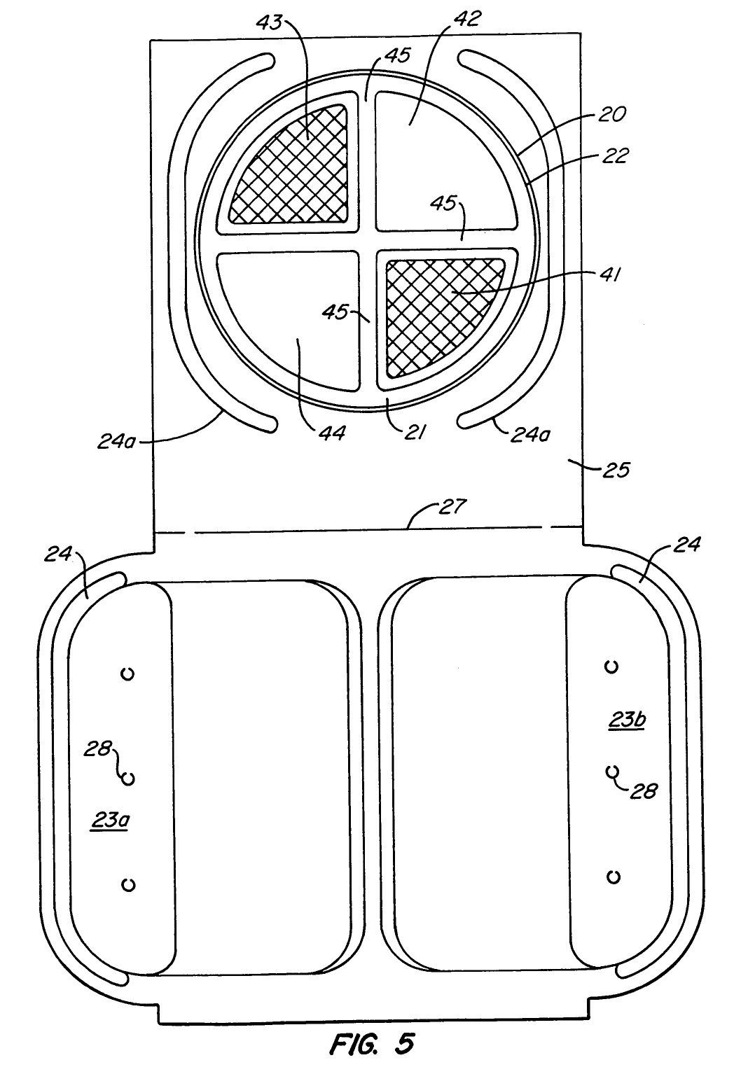

As may be seen in FIGS. 5-9, dispensing portions 23 of the tray are preferably formed such that they are fairly rigid and may handle the product that may be contained therein. Preferably, the tray includes two dispensing portions 23a, 23b that are separate. However more or less dispensing portions may be provided as desired and they may be separate or contiguous if desired. If used as hanging bird feeder, those skilled in the art will understand that the container and tray will need to be balanced with regard to the number of and/or arrangement of the dispensing trays.

The shape of the dispensing portions is preferably slightly curved so as to help provide stability. Furthermore, end portions 23c are slightly deeper with such a design and thereby provide a larger portion for receiving product such as bird feed. Ridges 24 are preferably provided that allow for birds to perch on tray 11 while feeding. Ridges 24a may also be provided if desired for perching, stability or decoration.

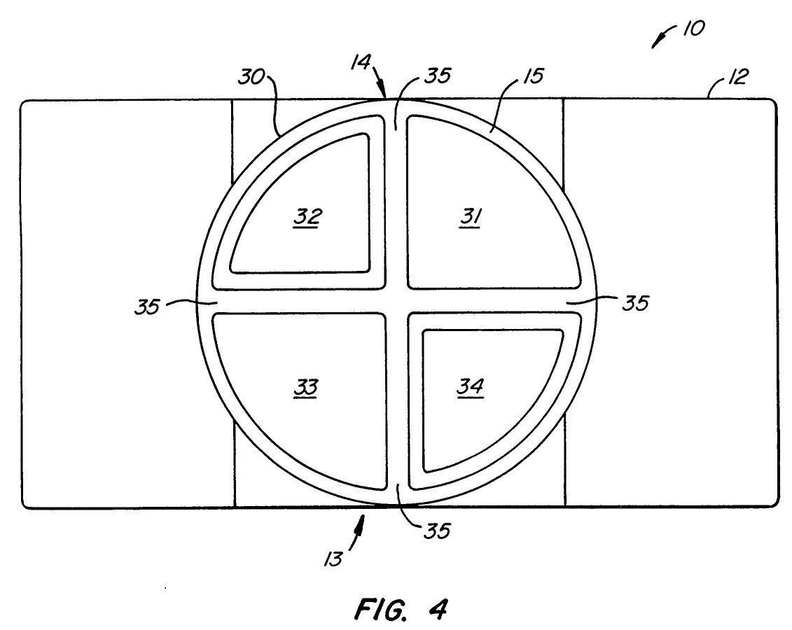

As may be seen in FIG. 4 and as previously mentioned, the neck is preferably covered with cap 14. In a preferred embodiment, the cap is divided into four quadrants 31, 32, 33, 34 with two of the quadrants 31, 33 being covered and the other two quadrants 32, 34 being open. Preferably, the quadrants are defined with ridges 35. The ridges have a height substantially equivalent to ridge 15 The cap may be coupled to the neck by welding, adhesive, snap-fit, or any other suitable manner known in the art.

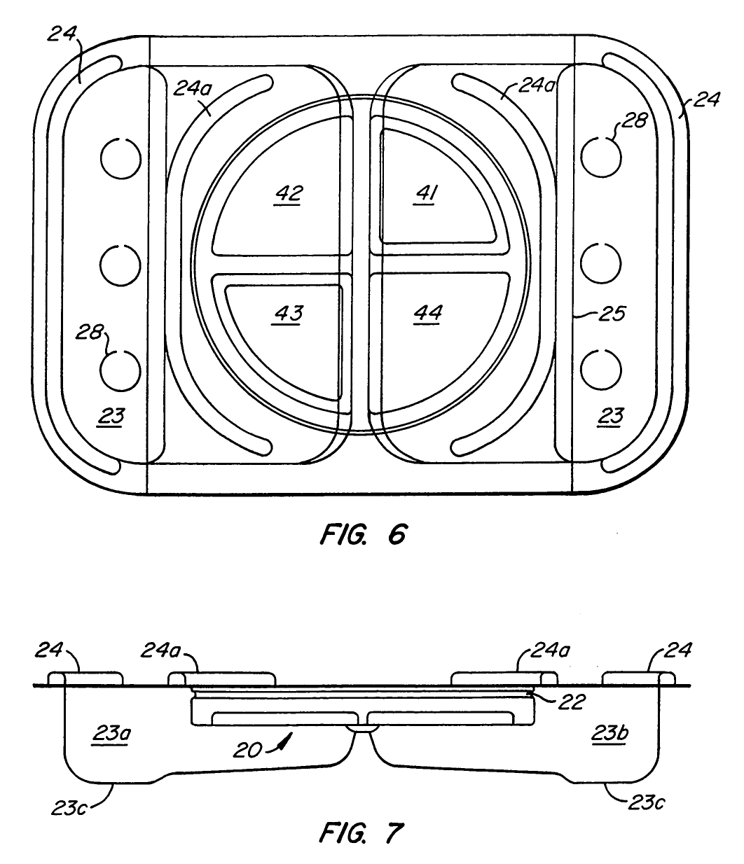

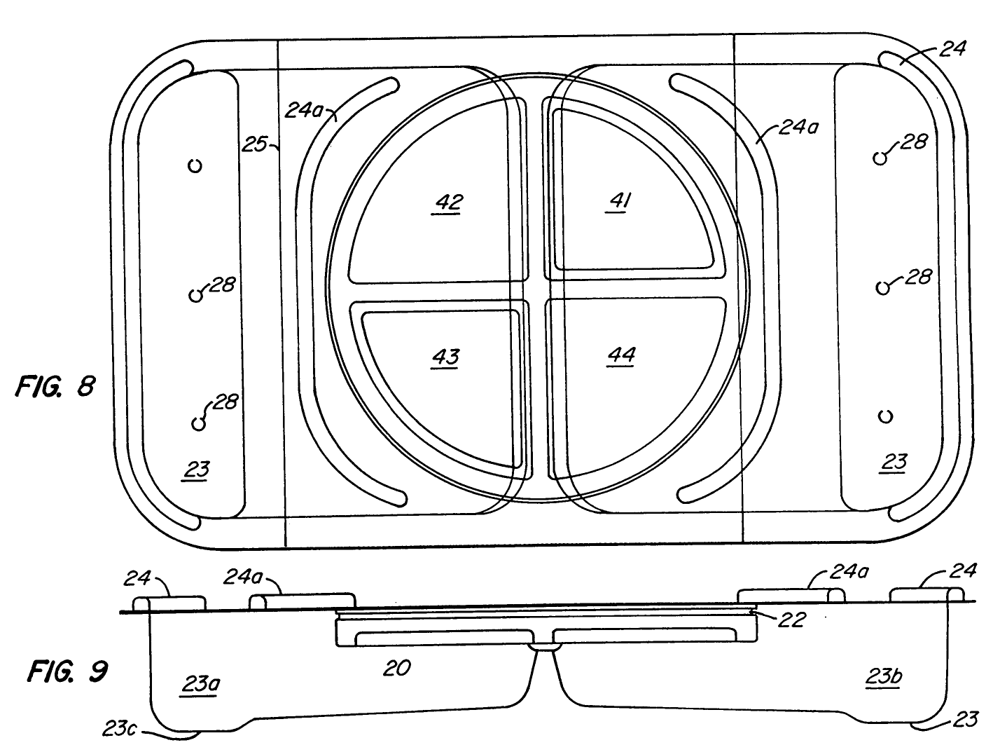

As may be seen in FIGS. 6 and 8, circular receptacle 20 is also divided into four quadrants 41, 42, 43, 44 with two quadrants 41, 43 being covered and the other two quadrants 41, 43 being open. Additionally, indentations 45 are preferably used to define the quadrants. Indentations 45 are preferably the same depth as depression 21.

Thus, when the container and tray are coupled to one another, the ridges and indentations may engage with one another. The neck of the container may rotate within the receptacle (ridge 15 within depression 21 and protrusion 22 within depression 16) and thus, the covered quadrants within the neck may align with the covered quadrants on the receptacle and product contained within the container may flow through the aligned open quadrants and into dispensing portions 22 of the tray. If one does not wish to have product flowing into the dispensing portions of the tray, the container and the tray may be rotated relative to one another such that the openings are misaligned and therefore, covered quadrants within the neck will close the open quadrants within the receptacle, and the covered quadrants within the receptacle will close the open quadrants within the neck. Ridges 35 cooperate with indentations 45 to provide an interference fit and help hold the container and tray in position relative to one another by inhibiting rotation without application of some amount of force.

As may be further seen in FIG. 5, circular receptacle 20 is preferably coupled to tray 11 with web 25. The web is preferably extruded or formed with the tray with an end, for example end 26, extending from the tray and then being folded over the tray. The end is then preferably coupled to the tray by welding end 26, but may be coupled to the tray by other suitable methods, such as, for example, with adhesive. Additionally, for added stability end 27 may also be coupled to the tray by welding, adhesive, etc. to the tray. Web 25 may also be formed as a separate piece and then both ends would be coupled to the tray by welding or adhesive or any other suitable way.

When the container and tray are used as a bird feeder, preferably the dispensing portions include at least one partial opening 28 defined therein so that water, such as rain, may drain out of the dispensing portions. As may be seen in FIG. 4, preferably the hole or opening is small and/or at least partially covered so as to prevent bird seed or feed from falling therethrough.

Examples of dimensions for the various components include a height H in a range of approximately four inches to eight inches, a width W in a range of two and a half to five inches, and a length L in a range of four to eight inches for container 10; and a length L′ in a range of five to nine inches, a height H′ in a range of one quarter to one and a half inches, and a width W′ in a range of three and a half to five and a half inches for dispensing tray 11. An example of a radius R for neck 13, cap 14 and receptacle 20 is in a range of one and a quarter to two and a half inches.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A container that selectively dispenses items contained therein, the container comprising:
a body including two opposing openings; and
a removable dispensing tray that may be coupled with the body with a snap-in coupling and includes two opposing openings;
wherein when the body is coupled to the tray, the body and tray may rotate relative to one another such that the openings may be aligned to an open position so that items may move from the body to the tray, and the openings may be misaligned to a closed position so that items are prevented from moving from the body to the tray.

2. A container in accordance with claim 1 wherein the two openings defined within the body are diagonally opposed from one another, and the two openings defined within the tray are diagonally opposed from one another.

3. A container in accordance with claim 1 wherein the body includes a circular neck with a body cover coupled thereto that includes the two openings defined therein and the tray includes a web that includes a circular depression having a depression cover with the two openings defined therein, the circular neck fitting within the circular depression in order to couple the tray and body together.

4. A container in accordance with claim 1 further comprising holes defined with the tray.

5. A container in accordance with claim wherein the container consists of deformable plastic.

6. A container in accordance with claim wherein the container is a disposable bird feeder.

7. A container in accordance with claim 1 further comprising structure for inhibiting rotation via an interference fit.

8. A container in accordance with claim 7 wherein the structure comprises cooperating ribs defined within the body and the tray.

9. A container in accordance with claim 1 wherein the tray includes two compartments that each include at least one deep portion defined therein.

10. A container in accordance with claim 3 wherein the web is welded to the tray at at least one location.

11. A container in accordance with claim 3 wherein the web is coupled to the tray at at least one location with adhesive.

12. A container in accordance with claim 3 wherein the body cover is welded to the neck.

13. A bird feeder in accordance with claim 3 wherein the body cover is coupled to the neck with adhesive.

14. A disposable bird feeder made of deformable plastic and comprising:
a body including a circular neck with a body cover that includes two opposing openings defined therein; and
a removable dispensing tray that may be coupled with the body with a snap-in coupling and includes a web that includes a circular depression having a depression cover with two opposing openings defined therein;
wherein the circular neck fits within the circular depression in order to couple the tray and body together, and the body and tray may rotate relative to one another such that the openings may be aligned to an open position so that items may move from the body to the tray, and the openings may be misaligned to a closed position so that items are prevented from moving from the body to the tray; and
wherein the snap-in coupling comprises an indentation defined around a periphery of the body cover and neck, and a cooperating protrusion defined within a periphery of the circular depression.

15. A bird feeder in accordance with claim 14 wherein the two openings defined within the body are diagonally opposed from one another, and the two openings defined within the tray are diagonally opposed from one another.

16. A bird feeder in accordance with claim 14 further comprising holes defined with the tray.

17. A bird feeder in accordance with claim 14 further comprising structure for inhibiting rotation via an interference fit.

18. A bird feeder in accordance with claim 17 wherein the structure comprises cooperating ribs defined within the body and the tray.

19. A bird feeder in accordance with claim 14 wherein the tray includes two compartments that each include at least one deep portion defined therein.

20. A bird feeder in accordance with claim 14 wherein the web is welded to the tray at at least one location.

21. A bird feeder in accordance with claim 14 wherein the body cover is welded to the neck.

22. A bird feeder in accordance with claim 14 wherein the body cover is coupled to the neck with adhesive.

23. A bird feeder in accordance with claim 14 wherein the web is coupled to the tray at at least one location with adhesive.
